(19) United States
(12) Patent Application Publication
(10) Pub. No.: US 2024/0202247 A1
(43) Pub. Date: Jun. 20, 2024

(54) CONTROL METHOD, RECORDING MEDIUM, AND INFORMATION PROCESSING DEVICE

(71) Applicant: Fujitsu Limited, Kawasaki-shi (JP)

(72) Inventors: Keita KOBAYASHI, Hiratsuka (JP); Fumiya KOBAYASHI, Sagamihara (JP); Shun ISHIHARA, Nagoya (JP); Ryu SHINZAKI, Ota (JP); Yu HASHIMOTO, Ota (JP); Koichi YAMASAKI, Kawasaki (JP)

(73) Assignee: Fujitsu Limited, Kawasaki-shi (JP)

(21) Appl. No.: 18/483,782

(22) Filed: Oct. 10, 2023

(30) Foreign Application Priority Data
Dec. 20, 2022 (JP) 2022-203798

(51) Int. Cl. G06F 16/903; G06F 16/901

(52) U.S. Cl. CPC G06F 16/90335; G06F 16/9024

(57) ABSTRACT

A control method executed by a computer, the control method includes: generating, when specification of a first data table constituting data to be retrieved is received, a data table copy that is a copy of the first data table, and switching the data to be retrieved, from the first data table to the data table copy; and performing a data retrieval process with respect to the data table copy, by controlling any one of a number of the data to be retrieved from the data table copy and a data retrieval interval, based on a load state estimated from a result of the data retrieval process.

### CROSS REFERENCE TO RELATED APPLICATIONS

This application is based upon and claims the benefit of priority of the prior Japanese Patent Application No. 2022-203798, filed on Dec. 20, 2022, the entire contents of which are incorporated herein by reference.

### FIELD OF THE INVENTION

The embodiments discussed herein are related to a control method, a recording medium, and an information processing device.

### BACKGROUND OF THE INVENTION

Recently, as an attempt to optimize a supply chain overall, data linking may be performed between databases of various stakeholders in the supply chain, such as manufacturers, wholesalers, retailers, etc. Data linking, for example, may be performed using an infrastructure database that can be accessed by each stakeholder rather than by being performed directly between the databases of the stakeholders.

According to one prior art, for example, when a query is derived based on a data extraction condition, by setting an upper limit of the number of times tables used by a database control program are integrated, control is performed so that the processing load when the query is executed does not become excessive. For example, refer to Japanese Laid-Open Patent Publication No. 2019-125283.

### SUMMARY OF THE INVENTION

According to an aspect of an embodiment, a control method executed by a computer, the control method includes: generating, when specification of a first data table constituting data to be retrieved is received, a data table copy that is a copy of the first data table, and switching the data to be retrieved, from the first data table to the data table copy; and performing a data retrieval process with respect to the data table copy, by controlling any one of a number of the data to be retrieved from the data table copy and a data retrieval interval, based on a load state estimated from a result of the data retrieval process.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting one example of a control method according to an embodiment.

FIG. 2 is a diagram depicting an example of system configuration of a data linking system 200.

FIG. 3 is a block diagram depicting an example of hardware configuration of a source server Si.

FIG. 4 is a diagram depicting one example of contents stored in a source DB information managing DB 230.

FIG. 5 is a diagram depicting one example of contents stored in a source DB 240.

FIG. 6 is a diagram depicting one example of storage contents of a load estimating information management table 250.

FIG. 7 is a block diagram depicting an example of a functional configuration of the source server Si.

FIG. 8 is a diagram depicting a detailed example of DB connection information.

FIG. 9 is a diagram depicting a detailed example of provided configuration data.

FIG. 10 is a diagram depicting an example of operation during data linking preparation work for the data linking system 200.

FIG. 11 is a diagram depicting an example of operation during routine operations of the data linking system 200.

FIG. 12 is a flowchart depicting one example of a procedure of a data linking pre-process of a data infrastructure server 201.

FIG. 13 is a flowchart depicting one example of a procedure of a data linking pre-process of the source server Si.

FIG. 14 is a flowchart depicting one example of a procedure of a record adding process of the source server Si.

FIG. 15 is a flowchart depicting one example of a procedure of a record extraction process of the source server Si.

FIG. 16 is a flowchart depicting a detailed example of a procedure of an extraction condition determining process.

FIG. 17 is a sequence diagram depicting an example of a data linking pre-process of the data linking system 200.

FIG. 18 is a sequence diagram depicting an example of the data linking pre-process of the data linking system 200.

FIG. 19 is a flowchart depicting one example of a procedure of a query generating process.

FIG. 20 is a flowchart depicting one detailed example of a procedure of a query executing process.

FIG. 21 is a sequence diagram of an example of a record extraction process of the data linking system 200.

FIG. 22 is a sequence diagram of an example of the record extraction process of the data linking system 200.

FIG. 23 is a sequence diagram of an example of the record extraction process of the data linking system 200.

FIG. 24 is a sequence diagram of one example of a data linking process of the data linking system 200.

### DESCRIPTION OF THE INVENTION

First, problems associated with the conventional techniques are discussed. When data linking between databases is performed by the conventional techniques, it is difficult to reduce the load on the databases while increasing the throughput of a data retrieval process with respect to the databases.

Embodiments of a control method, a recording medium, and an information processing device according to the present invention are explained with reference to the accompanying drawings.

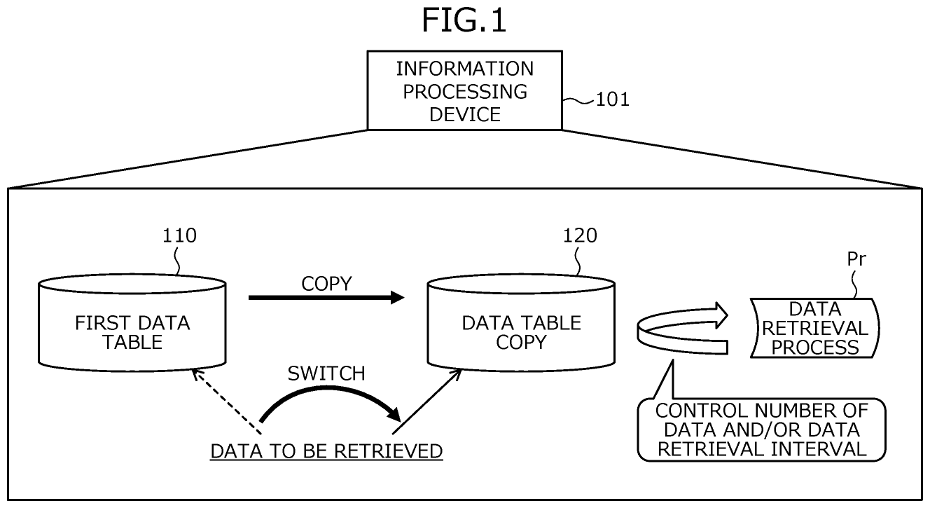

FIG. 1 is a diagram depicting one example of a control method according to an embodiment. In FIG. 1, an information processing device 101 is a computer that controls a database from which data is to be retrieved. Data retrieval corresponds to an extraction of data from a database to perform data linking.

If data linking can be performed between stakeholders in a supply chain, various types of information such as production, human resources, inventory, etc. may be seamlessly comprehended, whereby optimization of the supply chain overall may be expected. The data, for example, is physical distribution data, commercial distribution data, etc.

A supply chain represents a flow of a series of steps (for example, procurement, manufacture, delivery, sale, etc.) for a product to reach a consumer (supply network). Further, a stakeholder is an interested party in a business and, for example, is an enterprise, an individual, etc.

On the other hand, when data linking between databases is performed and a high load is placed on a source database, the throughput of a database (DB) application and/or the response time may be adversely affected. The DB application is an application that uses the source database.

Accordingly, it is important to suppress adverse effects on the throughput of the DB application and the response time while increasing the throughput of a process of retrieving data from a database. Nonetheless, with the conventional techniques, it is difficult to increase the throughput of a data retrieval process while dynamically controlling the load applied to the database to suppress adverse effects on the throughput of the DB application and the response time.

Thus, in the present embodiment, a method of reducing the load on a database by dynamically controlling a data retrieval interval and the number of data retrieved when data is repeatedly retrieved from a database is described. Here, an example of processing by the information processing device 101 is described.

(1) The information processing device 101 receives specification of a first data table, which is data to be retrieved. Here, the first data table, for example, is a table in a source database when data linking is performed. For example, the information processing device 101 has the first data table.

In the example depicted in FIG. 1, an instance is assumed in which a first data table 110 is specified. A linked database, for example, is an infrastructure database. An infrastructure database is a database for centrally managing data of multiple databases.

(2) The information processing device 101, when receiving specification of a first data table that is data to be retrieved, generates a data table copy that is a copy of the first data table and switches the data to be retrieved, from the first data table to the data table copy.

The data table copy, for example, is associated with the first data table and is provided on the same computer (the information processing device 101) as that of the first data table. In particular, for example, the data table copy, for example, is provided in the same databases at that of the first data table. For example, data newly stored to the first data table is sequentially copied to the data table copy. The data table copy is provided to reduce the impact on the first data table when the data linking is performed.

In the example depicted in FIG. 1, an instance is assumed in which a data table copy 120 that is a copy of the first data table 110 is generated and the data to be retrieved is switched from the first data table 110 to the data table copy 120.

(3) The information processing device 101, when implementing the data retrieval process with respect to the data table copy, controls at least any one of the number of data to be retrieved from the data table copy and the data retrieval interval, based on a load state estimated from a result of the data retrieval process. Here, the data retrieval process, for example, is performed iteratively. The data retrieval process being performed iteratively means that the data retrieval process is repeatedly performed for each data retrieval interval.

The load state, for example, is a load state of the information processing device 101 that has the first data table and the data table copy. In particular, for example, in an instance in which the first data table and the data table copy are provided in a single database, the load state corresponds to the load state of the single database. The load state, for example, is estimated based on the response time and/or success or failure of the data retrieval process with respect to the data table copy.

For example, the information processing device 101 may estimate the load to be high when the response time of the data retrieval process is at least equal to a threshold. Further, the information processing device 101 may estimate the load to be high when the data retrieval process fails due to a timeout or the like.

Further, the information processing device 101 may estimate the load to be low when the response time of the data retrieval process is less than the threshold. The first data retrieval process, for example, may be performed based on a predetermined number of data. For example, one (1) data is one (1) record in the database.

In particular, for example, the information processing device 101, when estimating the load to be high, may perform control so that the number of data to be retrieved in the data retrieval process is fewer as compared to a case when the load is low. Further, the information processing device 101, when estimating the load to be high, may perform control so that the data retrieval interval becomes longer as compared to a case when the load is low.

Further, the information processing device 101, when estimating the load to be low, may perform control so that the number of data to be retrieved in the data retrieval process becomes large as compared to a case when the load is high. Further, the information processing device 101, when estimating the load to be low, may perform control so that the data retrieval interval becomes short as compared to a case when the load is high.

In the example depicted in FIG. 1, the information processing device 101, when iteratively performing a data retrieval process Pr with respect to the data table copy 120, controls at least any one of the number of data to be retrieved from the data table copy 120 and the data retrieval interval, based on the load state estimated from a result of the data retrieval process Pr.

As described, according to the information processing device 101, the number of data and/or the data retrieval interval when data is iteratively retrieved from a database is dynamically controlled thereby, enabling the load on the database to be reduced.

In the example depicted in FIG. 1, the information processing device 101 may dynamically increase the number of data and/or the data retrieval interval according to the load state estimated from the results of the data retrieval process. As a result, the information processing device 101 may suppress adverse effects on the response time and/or throughput of another DB application while increasing the throughput of the data retrieval process for data linking. Another DB application, for example, is an application that uses a database that includes the first data table 110 and the data table copy 120.

Another computer different from the information processing device 101 may have the first data table 110 and the data table copy 120. In this case, the information processing device 101, for example, may communicate with the other computer and at the other computer, the number of data and/or the data retrieval interval when that data is retrieved from the data table copy 120 may be controlled. In particular, for example, when the data retrieval process is performed iteratively with respect to the data table copy 120 at the other computer, the information processing device 101 controls the number of data to be retrieved from the data table copy 120 and/or the data retrieval interval, based on the load state estimated from the results of the data retrieval process.

Next, an example of system configuration of a data linking system 200 that includes the information processing device 101 depicted in FIG. 1 is described. Here, an instance in which the information processing device 101 depicted in FIG. 1 is applied to source servers S1 to Sn (n: natural number equal to 2 or greater) in the data linking system 200 is described as an example. The data linking system 200, for example, is applied to a computer system that performs various types of data linking between databases.

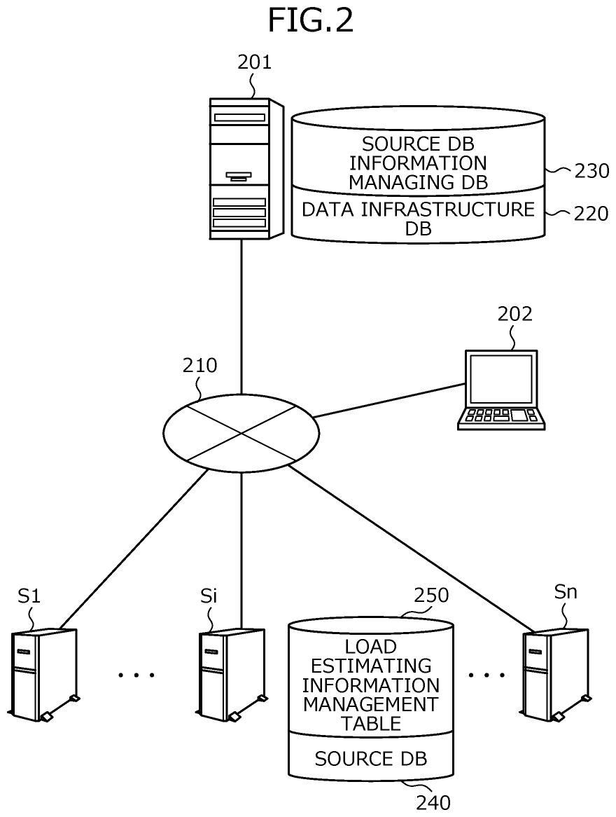

FIG. 2 is a diagram depicting an example of system configuration of the data linking system 200. In FIG. 2, the data linking system 200 includes a data infrastructure server 201, a manager terminal 202, and source servers S1 to Sn. In the data linking system 200, the data infrastructure server 201, the manager terminal 202, and the source servers S1 to Sn are connected to one another through a network 210 that may be wired or wireless. The network 210, for example, is the Internet, a local area network (LAN), a wide area network (WAN), etc.

In the description below, an arbitrary source server among the source servers S1 to Sn may be indicated as a “source server Si”. The information processing device 101 depicted in FIG. 1, for example, corresponds to the source server Si.

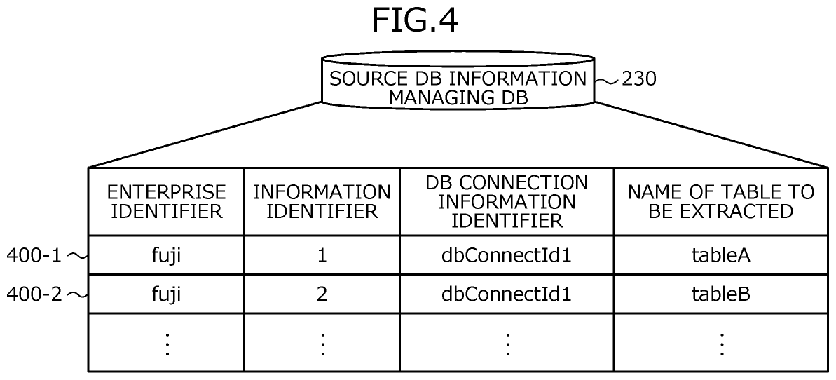

Here, the data infrastructure server 201 has a data infrastructure DB 220 and a source DB information managing DB 230 and is a computer that centrally manages data of multiple databases. The data infrastructure DB 220 is a linked database when data linking is performed. The source DB information managing DB 230 stores information of the source database. Storage contents of the source DB information managing DB 230 are described hereinafter with reference to FIG. 4.

The manager terminal 202 is a computer used by a user of the data linking system 200. The user, for example, is a manager of the source database. The manager terminal 202, for example, is a personal computer (PC), a tablet PC, etc.

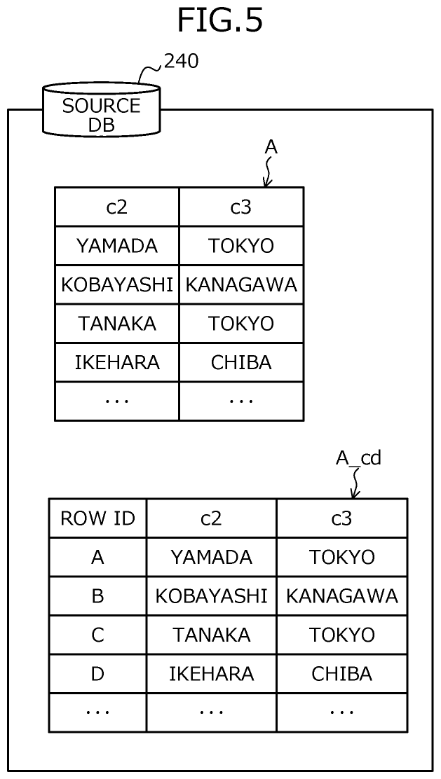

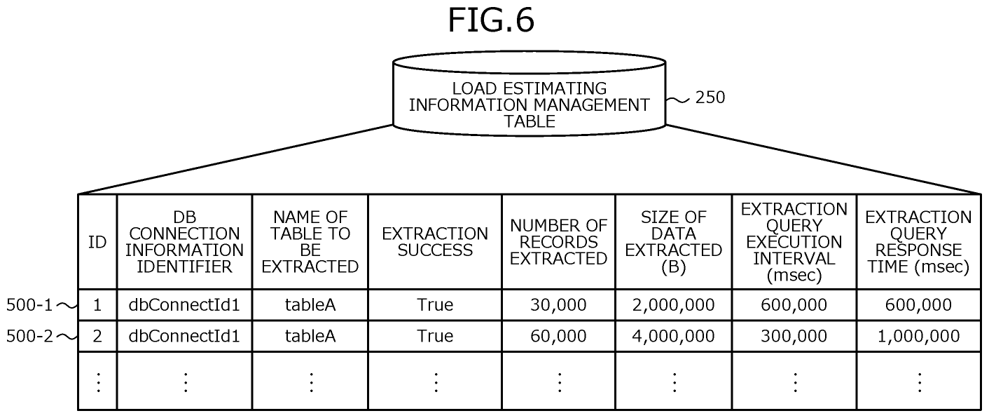

The source server Si has a source DB 240 and a load estimating information management table 250 and is a computer that controls a database constituting data to be retrieved. The source DB 240 corresponds to the source database and includes linked tables. Storage contents of the source DB 240 are described hereinafter with reference to FIG. 5. The load estimating information management table 250 stores load estimating information. Storage contents of the load estimating information management table 250 are described hereinafter with reference to FIG. 6.

Here, while the manager terminal 202 is depicted as a single device, the manager terminal 202, for example, may be provided for each of the source servers S1 to Sn, respectively.

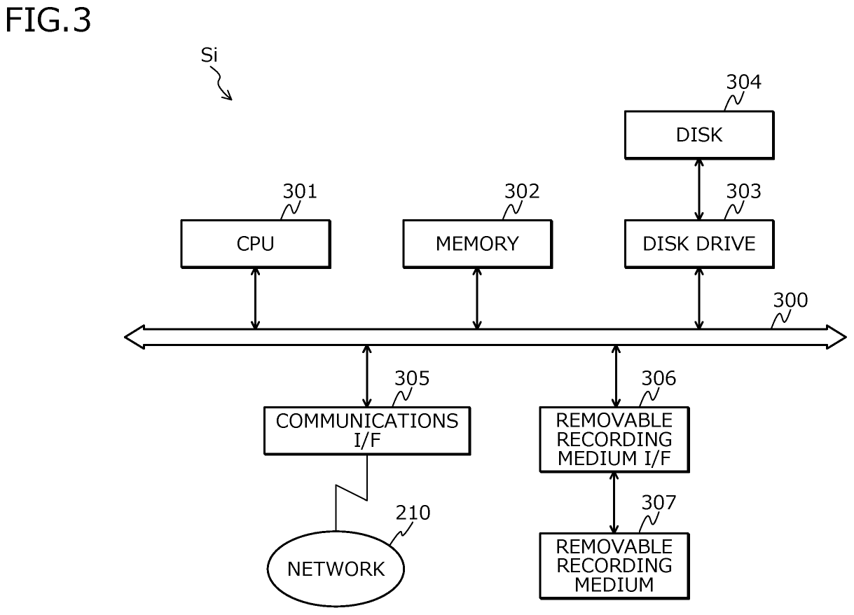

Next, an example of hardware configuration of the source server Si is described with reference to FIG. 3.

FIG. 3 is a block diagram depicting an example of hardware configuration of the source server Si. In FIG. 3, the source server Si has a central processing unit (CPU) 301, a memory 302, a disk drive 303, a disk 304, a communications interface (I/F) 305, a removable recording medium I/F 306, and a removable recording medium 307. Further, these components are connected to one another by a bus 300.

Here, the CPU 301 governs overall control of the source server Si. The CPU 301 may have multiple cores. The memory 302, for example, includes a read-only memory (ROM), a random access memory (RAM), and a flash ROM, etc. In particular, for example, the flash ROM stores OS programs, the ROM stores application programs, and the RAM is used as a work area of the CPU 301. Programs stored to the memory 302 are loaded onto the CPU 301, whereby encoded processes are executed by the CPU 301.

The disk drive 303, under the control of the CPU 301, controls the reading and writing of data with respect to the disk 304. The disk 304 stores data written thereto under the control of the disk drive 303. The disk 304 may be, for example, a magnetic disk, an optical disk, etc.

The communications I/F 305 is connected to the network 210 through a communications line and is connected to an external computer (for example, the data infrastructure server 201 and the manager terminal 202 depicted in FIG. 2) through the network 210. Further, the communications I/F 305 administers an internal interface with the network 210 and controls the input and output of data from an external computer. The communications I/F 305 may be, for example, a modem, a LAN adapter, etc.

The removable recording medium I/F 306, under the control of the CPU 301, controls the reading and writing of data with respect to the removable recording medium 307. The removable recording medium 307 stores data written thereto under the control of the removable recording medium I/F 306. The removable recording medium 307 may be, for example, a compact disc (CD)-ROM, a Digital Versatile Disk (DVD), universal serial bus (USB) memory, etc.

The source server Si, in addition to the components described above, for example, may further have an input device, a display, etc. Further, of the components described above, for example, the source server Si, may omit the removable recording medium I/F 306 and the removable recording medium 307. Further, the data infrastructure server 201 and the manager terminal 202 depicted in FIG. 2 may also be implemented by a same hardware configuration as that of the source server Si. However, the manager terminal 202, in addition to the components described above, for example, has an input device, a display, etc.

Next, storage contents of the source DB information managing DB 230 of the data infrastructure server 201 are described with reference to FIG. 4. The source DB information managing DB 230, for example, is implemented by a storage device such as a disk or memory of the data infrastructure server 201.

FIG. 4 is a diagram depicting one example of the contents stored in the source DB information managing DB 230. In FIG. 4, the source DB information managing DB 230 has fields for enterprise identifiers, information identifiers, DB connection information identifiers, and names of tables to be extracted; information is set into each of the fields, whereby the provided configuration data (for example, provided configuration data 400-1, 400-2) are stored as records.

Here, an enterprise identifier is an identifier that identifies a linkage-source enterprise. A linkage-source enterprise is an operator of the source server Si and, for example, is a stakeholder belonging to the supply chain. An information identifier is an identifier that identifies provided configuration data. A DB connection information identifier is an identifier that identifies DB connection information. DB connection information is information used in connecting to a source database (for example, the source DB 240). A name of a table to be extracted is a name of a linked table.

For example, the provided configuration data 400-1 has an enterprise identifier “fuji”, an information identifier “1”, a DB connection information identifier “dbConnectId1”, and a name of a table to be extracted “table A”.

Next, storage contents of the source DB 240 of the source server Si are described with reference to FIG. 5. The source DB 240, for example, is implemented by a storage device such as the memory 302, the disk 304 of the source server Si, etc.

FIG. 5 is a diagram depicting one example of the contents stored in the source DB 240. In FIG. 5, the source DB 240 includes table A and a change difference management table A_cd. Table A is one example of a linked table (database). Table A has columns c2 and c3, and information is set in each of the columns and is thereby stored as records. The first data table 110 depicted in FIG. 1, for example, corresponds to table A.

The change difference management table A_cd stores therein data stored to table A. The change difference management table A_cd has columns ROW ID, c2, and c3, and information is set into each of the columns and is thereby stored as records. The data table copy 120 depicted in FIG. 1, for example, corresponds to the change difference management table A_cd.

Next, storage contents of the load estimating information management table 250 of the source server Si are described with reference to FIG. 6. The load estimating information management table 250, for example, is implemented by a storage device such as the memory 302, the disk 304 of the source server Si, etc.

FIG. 6 is a diagram depicting one example of storage contents of the load estimating information management table 250. In FIG. 6, the load estimating information management table 250 has fields for IDs, DB connection information identifiers, names of tables to be extracted, extraction success, number of records extracted, size of data extracted, extraction query execution interval, and extraction query response time. Information is set into each of the fields, whereby load estimating information (for example, load estimating information 500-1, 500-2) is stored as records.

Here, an ID is an identifier that identifies load estimating information. A DB connection information identifier is an identifier that identifies DB connection information. A name of a table to be extracted is a name of a linked table. Extraction success indicates whether an extraction process is successful. A number of records extracted indicates the number of records extracted by the extraction process. A size of data extracted indicates the size of the data extracted by the extraction process (unit: bytes (B)). An extraction query execution interval indicates an execution interval of the extraction process (unit: msec). An extraction query response time indicates the response time of the extraction process (unit: msec).

For example, the load estimating information 500-1 has ID “1”, DB connection information identifier “dbConnectId1”, name of a table to be extracted “table A”, extraction success “True”, number of records extracted “30,000”, size of data extracted “2,000,000”, extraction query execution interval “600,000”, and extraction query response time “600,000”.

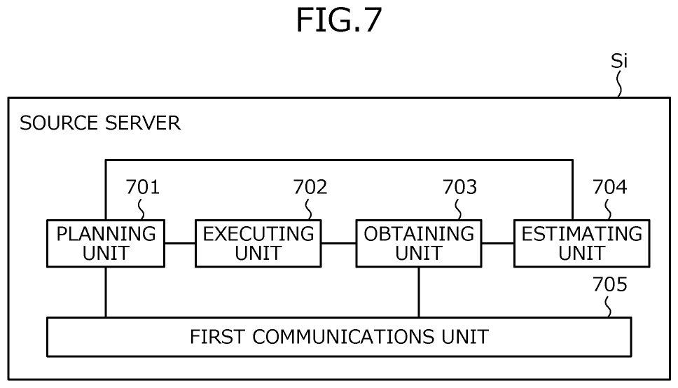

FIG. 7 is a block diagram depicting an example of a functional configuration of the source server Si. In FIG. 7, the source server Si includes a planning unit 701, an executing unit 702, an obtaining unit 703, an estimating unit 704, and a first communications unit 704. The planning unit 701 to the first communications unit 704 are functions constituting a controller and, for example, the functions are implemented by executing on the CPU 301 or by the communications I/F 305, a program stored in a storage device such as the memory 302, the disk 304, the removable recording medium 307, etc. depicted in FIG. 3. Process results of each of the functional units, for example, are stored to a storage device such as the memory 302, the disk 304, etc.

The planning unit 701 receives specification of a first data table constituting data to be retrieved. Here, the first data table is a table in the source database when data linking is performed. Specification of the first data table, for example, is performed by specifying the source database and a linked table (name of a table to be extracted).

In particular, for example, the planning unit 701 receives DB connection information from the manager terminal 202 depicted in FIG. 2 and as a result, sets the received DB connection information in a configuration file (not depicted). The DB connection information is information for accessing the source database. Subsequently, the planning unit 701 refers to the received DB connection information and creates the load estimating information management table 250 like that depicted in FIG. 6.

Further, the planning unit 701 receives the provided configuration data from the data infrastructure server 201 depicted in FIG. 2 and thereby receives specification of a first data table constituting the data to be retrieved. The provided configuration data is information for managing, at the data infrastructure server 201, the source database and linked tables.

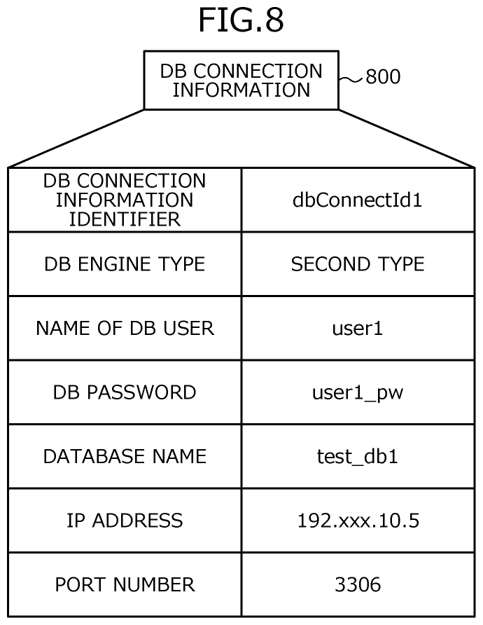

Here, a detailed example of the DB connection information is described with reference to FIG. 8.

FIG. 8 is a diagram depicting a detailed example of the DB connection information. In FIG. 8, DB connection information 800 includes a DB connection information identifier, a DB engine type, a name of a DB user, a DB password, a database name, an IP address, and a port number.

Here, the DB connection information identifier is an identifier that identifies the DB connection information. The DB engine type indicates the type of the DB engine of the source database. The DB engine is software for operating a database and is used to create, update, delete, and search data of a database.

The DB engine type may be, for example, OracleL (registered trademark), MySQL (registered trademark), PostgreSQL (registered trademark), etc. Here, the DB engine types are assumed to be three types of DB engines including a first type, a second type, and a third type.

The name of a DB user is the name of a user of the source database. The DB password is a password for using the source database. The database name is the name of the source database. The IP address and the port number are an IP address and a port number for connecting to the source database.

For example, the planning unit 701 refers to the DB connection information 800 and creates the load estimating information management table 250 having the DB connection information identifier “dbConnectId1”.

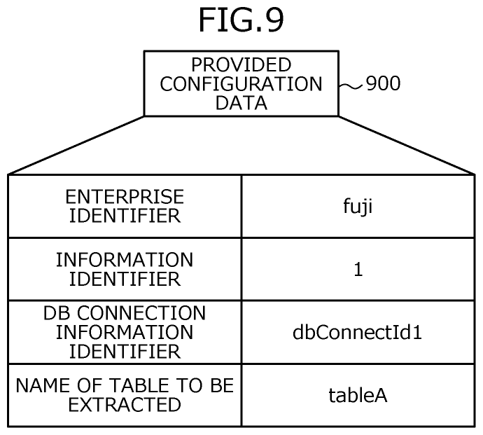

Next, a detailed example of the provided configuration data is described with reference to FIG. 9.

FIG. 9 is a diagram depicting a detailed example of the provided configuration data. In FIG. 9, provided configuration data 900 includes an enterprise identifier, an information identifier, a DB connection information identifier, and a name of a table to be extracted. Here, the enterprise identifier is an identifier that identifies a linkage-source enterprise. The information identifier is an identifier that identifies the provided configuration data. The DB connection information identifier is an identifier that identifies DB connection information. The name of a table to be extracted is the name of a linked table.

From the provided configuration data 900, the planning unit 701 may identify the source database to be a database having the DB connection information identifier “dbConnectId1” and may identify the linked table to be a table that is to be extracted having the name “table A”.

Here, description with reference to FIG. 7 further continues; the planning unit 701 generates a query for creating a data table copy that corresponds to the specified first data table. The data table copy is for copying data stored in the first data table. The data table copy, for example, is provided in the same database as that of the first data table and is manipulated by a DB engine that is of the same type.

For example, the first data table is assumed to be “table A (linked table) in the source DB”. In this case, the data table copy, for example, is the change difference management table A_cd depicted in FIG. 5. Table A and the change difference management table A_cd are included in the source DB 240.

In the description herein after, the specified first data table may be denoted as “table to be extracted” and a data table copy corresponding to the first data table may be denoted as “change difference management table”.

Here, an optimal query for creating a change difference management table may differ depending on the DB engine. Therefore, the planning unit 701, for example, refers to the DB connection information and identifies the DB engine type of the specified first data table. Subsequently, based on the identified DB engine type, the planning unit 701 generates a query for manipulating the data table copy.

For example, the planning unit 701 may generate a change difference management table creating query based on the identified DB engine type. Information (table configuration) of the change difference management table, for example, may be identified from a system table (not depicted) of the first data table.

Further, the planning unit 701 generates a query for copying data stored in the specified first data table. Here, the syntax of queries for retrieving data from a table (for example, a table to be extracted), queries for inserting data into a table (for example, change difference management table), etc. may differ depending on the DB engine.

Therefore, the planning unit 701, for example, refers to the DB connection information and identifies the DB engine type of the specified first data table. Subsequently, the planning unit 701 may generate a trigger creating query based on the identified DB engine type. The trigger is for inserting, into the change difference management table, information that is the same as that of a record inserted into the table to be extracted.

The executing unit 702, when receiving specification of the first data table constituting data to be retrieved, copies data stored in the first data table into the data table copy and switches the data to be retrieved, from the first data table to the data table copy.

In particular, for example, the executing unit 702 executes the generated change difference management table creating query and thereby, creates the change difference management table for copying the data stored in the table that is to be extracted (first data table). Further, the executing unit 702 creates a trigger by executing the generated trigger creating query. Subsequently, the executing unit 702 executes the created trigger and thereby copies, into the change difference management table, data that is stored in the table to be extracted and switches the data to be retrieved, from the table to be extracted to the change difference management table.

Further, the executing unit 702 iteratively performs the data retrieval process with respect to the data table copy. Here, the data retrieval process is a process of retrieving from the data table copy, a predetermined number of data. In particular, for example, the executing unit 702 performs the data retrieval process with respect to the data table copy at predetermined intervals and thereby iteratively retrieves data from the data table copy.

In particular, for example, the executing unit 702 executes a record extraction query with respect to the change difference management table and thereby extracts a record from the change difference management table. The record extraction query is a query for performing the data retrieval process and is a query for extracting, from the change difference management table, a predetermined number (a predetermined extraction item count) of records.

The record extraction query, for example, is generated by the planning unit 701 and is executed at each query execution interval determined by the planning unit 701. However, the first record extraction query, for example, may be generated in advance and stored to a storage device such as the memory 302, the disk 304, etc.

The obtaining unit 703 obtains results of the data retrieval process performed with respect to the data table copy. In particular, for example, the obtaining unit 703 obtains the result of extracting a record by the execution of the record extraction query. Further, the obtaining unit 703 calculates the extraction query response time and the extraction query execution interval.

The extraction query response time, for example, may be obtained by “time extraction result is obtained-time extraction query is executed”. “Time extraction result is obtained” indicates the time at which the record extraction result was obtained. “Time extraction query is executed” indicates the time at which the record extraction query was executed. “Time extraction query is executed”, for example, may be identified from a log of the executing unit 702. The extraction query execution interval, for example, may be obtained by “time extraction query is executed for (N+1)-th session-time extraction query is executed for N-th session” (N: natural number).

Subsequently, the obtaining unit 703 registers load estimating information, which includes the calculated extraction query response time and extraction query execution interval, into the load estimating information management table 250 depicted in FIG. 6. The load estimating information includes, for example, a DB connection information identifier, the name of a table to be extracted, extraction success, the number of records extracted, and the size of data extracted.

The DB connection information identifier is an identifier that identifies DB connection information. The name of a table to be extracted is the name of a table (linked table) to be extracted. “Extraction success” indicates whether the extraction process (record extraction query) was successful. The number of records extracted indicates the number of records extracted by the extraction process. The size of data extracted indicates the size of the data extracted by the extraction process.

Further, when the data retrieval process is successful with respect to the data table copy, the executing unit 702 deletes the retrieved data from the data table copy. In particular, for example, when execution of the record extraction query results in the extraction process of extracting a record from the change difference management table being successful, the executing unit 702 deletes the extracted record from the change difference management table.

In particular, for example, the executing unit 702 executes the record deletion query with respect to the change difference management table and thereby deletes the record from the change difference management table. The record deletion query, for example, is generated based on the DB engine type of the first data table and information in the change difference management table.

The estimating unit 704 estimates the load state based on the result of the data retrieval process being performed with respect to the data table copy. The load state represents the load state of the source server Si when the data retrieval process is performed with respect to the data table copy. In particular, for example, the load state corresponds to the load state of the source DB 240 when the record deletion query was executed with respect to the change difference management table.

In particular, for example, the estimating unit 704 may estimate the load state, based on the success or failure of the data retrieval process (whether the data retrieval process succeeds or fails). The success or failure of the data retrieval process, for example, the “extraction success” field in the load estimating information of the load estimating information management table 250. In particular, for example, when the “extraction success” field indicates “True”, the estimating unit 704 estimates the load (the load state) to be low. On the other hand, when the “extraction success” field indicates “False”, the estimating unit 704 estimates the load (the load state) to be high.

Further, the estimating unit 704 may estimate the load state based on the response time of the data retrieval process. The response time of the data retrieval process, for example, is identified from the extraction query response time of the load estimating information of the load estimating information management table 250. In particular, for example, when the extraction query response time is less than a threshold a, the estimating unit 704 estimates the load (the load state) to be low. On the other hand, when the extraction query response time is at least equal to the threshold a, the estimating unit 704 estimates the load (the load state) to be high. The threshold a is a threshold related to the response time of a query and may be arbitrarily set.

Further, to iteratively implement the data retrieval process with respect to the data table copy, the planning unit 701 controls any one of the number of data to be retrieved from the data table copy and the data retrieval interval based on the estimated load state. The data retrieval interval corresponds to an execution interval of the data retrieval process.

In particular, for example, when the load is estimated to be high, the planning unit 701 controls the number of data to be retrieved in the data retrieval process to be smaller than that in a case when the load is low. Further, when the load is estimated to be high, the planning unit 701 may control the data retrieval interval to be longer than that in a case when the load is low.

Further, for example, when the load is estimated to be low, the planning unit 701 may control the number of data to be extracted in the data retrieval process to be greater than that when the load is high. Further, when the load is estimated to be low, the planning unit 701 may control the data retrieval interval to be shorter than that when the load is high.

In particular, for example, the planning unit 701 determines at least any one of the extraction item count and the extraction query execution interval for the next session, based on the number of records extracted, the size of the data extracted, the extraction query execution interval, the extraction query response time, etc. included in the load estimating information of the load estimating information management table 250.

The extraction item count indicates the number of records to be extracted from the change difference management table and corresponds to the number of data to be extracted from the data table copy. The extraction query execution interval indicates the record execution interval for executing an extraction query and corresponds to the data retrieval interval for retrieving data from the data table copy. An example of determining the extraction item count and the extraction query execution interval is described hereinafter.

Subsequently, the planning unit 701 generates a record extraction query based on the determined extraction item count. The record extraction query is query for extracting records of the determined extraction item count from the change difference management table and is generated based on information in the change difference management table. At this time, the planning unit 701 may generated a record extraction query based on the identified DB engine type.

The executing unit 702 performs the data retrieval process with respect to the data table copy based on the controlled number of data and the controlled data retrieval interval. In particular, for example, after the executing unit 702 executes the previous record extraction query, the executing unit 702 stands by until the determined extraction query execution interval elapses. Subsequently, after the extraction query execution interval elapses, the executing unit 702 executes the generated record extraction query.

For example, the data retrieval interval is assumed to be fixed in an instance in which only the number of data is controlled among the number of data to be retrieved from the data table copy and the data retrieval interval. In this case, the executing unit 702, for example, after executing the previous record extraction query, executes the generated record extraction query after the execution interval elapses.

Further, for example, the number of data is assumed to be fixed in an instance in which only the data retrieval interval is controlled among the number of data to be retrieved from the data table copy and the data retrieval interval. In this case, for example, the executing unit 702, after executing the previous record extraction query, executes the record extraction query for extracting records of the predetermined extraction item count, after the determined extraction query execution interval elapses.

The first communications unit 704 outputs the data retrieved by the execution of the data retrieval process, to a linked database of the first data table. The linked database, for example, is the data infrastructure DB 220 depicted in FIG. 2. In particular, for example, the first communications unit 704 transmits, to the data infrastructure server 201 depicted in FIG. 2, the records extracted by the execution of the record extraction query (record extraction result) and thereby outputs the records with respect to the data infrastructure DB 220.

Here, an example of determining the extraction item count of the records that are to be extracted from the change difference management table and the extraction query execution interval at which a record extraction query is executed is described.

Here, an instance is assumed in which the load state is represented by a “busy level X” and a “busy level Y”. The busy level X is the load state for determining the extraction item count. The busy level X is expressed as “True” or “False” according to success of extraction. For example, when the “extraction success” is “True”, the busy level X is “True”. On the other hand, when the “extraction success” is “False”, the busy level X is “False”.

The busy level Y is the load state for determining the extraction query execution interval. The busy level Y is expressed as “True” or “False” according to extraction success and the extraction query response time. For example, when the “extraction success” is “True”, the busy level Y is “True”. On the other hand, when the “extraction success” is “False”, the busy level Y is “False”. Further, when the extraction query response time is less than the threshold a, the busy level Y is “True”. On the other hand, when the extraction query response time is at least equal to the threshold a, the busy level Y is “False”.

For example, when the busy level X is “True”, the planning unit 701 uses formula (1) below and determines the extraction item count for the next session. The maximum number of rows to be retrieved may be arbitrarily set in advance and is set so that the extraction item count does not become excessive. “b” indicates the number of records extracted by the extraction process of the previous session. The initial value (first extraction item count) of “b” is preset.

$$min ( b \times 2 , maximum number of rows to be retrieved ) \qquad ( 1 )$$

Further, when the busy level X is “False”, the planning unit 701 uses formula (2) below and determines the extraction item count for the next session. The minimum number of rows to be retrieved may be set arbitrarily and is set so that the extraction item count does not become excessively small.

$$max ( b \div 2 , minimum number of rows to be retrieved ) \qquad ( 2 )$$

For example, when the busy level Y is “True”, the planning unit 701 uses formula (3) below and determines the extraction query execution interval for the next session. A minimum execution interval may be arbitrarily set in advance and the extraction query execution interval is set so as to not become too short. “a” represents the extraction query execution interval of the first session. The initial value of “a” (the first extraction item count) is preset.

$$max ( a \div 2 , minimum execution interval ) \qquad ( 3 )$$

Further, when the busy level Y is “False”, the planning unit 70 uses formula (4) below and determines the extraction query execution interval for the next session. The maximum execution interval may be arbitrary preset and is set so that the extraction query execution interval does not become excessively long.

$$min ( a \times 2 , maximum execution interval ) \qquad ( 4 )$$

As one example, a case is described in which the load state (the busy level X, the busy level Y) is assumed to be estimated based on the load estimating information 500-2 in the load estimating information management table 250. Further, the maximum number of rows to be retrieved is assumed to be “100,000” and the minimum number of rows to be retrieved is assumed to be “1”. Further, the maximum execution interval is assumed to be “5,000,000(msec)” and the minimum execution interval is assumed to be “100(msec)”. Further, the threshold a is assumed to be “800,000(msec)”.

In this case, the busy level X is “True”. Thus, from formula (1) above, the extraction item count for the next session is “min(bx2, maximum number of rows to be retrieved)=min(60000×2,100000)=min(120000,100000)=100000”.

Further, the extraction query response time is at least equal to the threshold a and therefore, the busy level Y is “False”. Thus, from formula (4) above, the extraction query execution interval for the next session is “min(ax2, the maximum execution interval)=min(300000×2,5000000)=min(600000,5000000)=600000”.

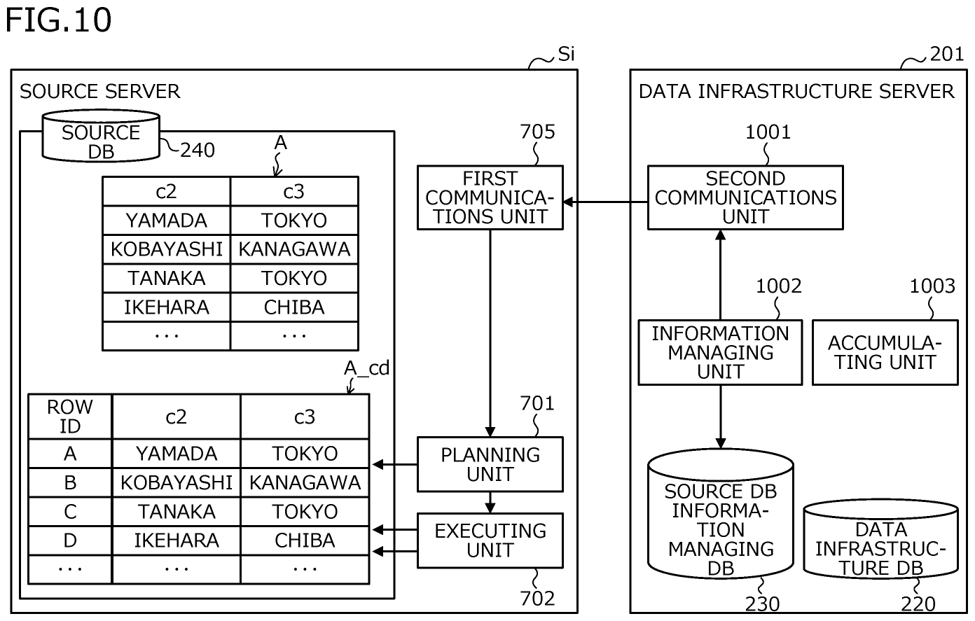

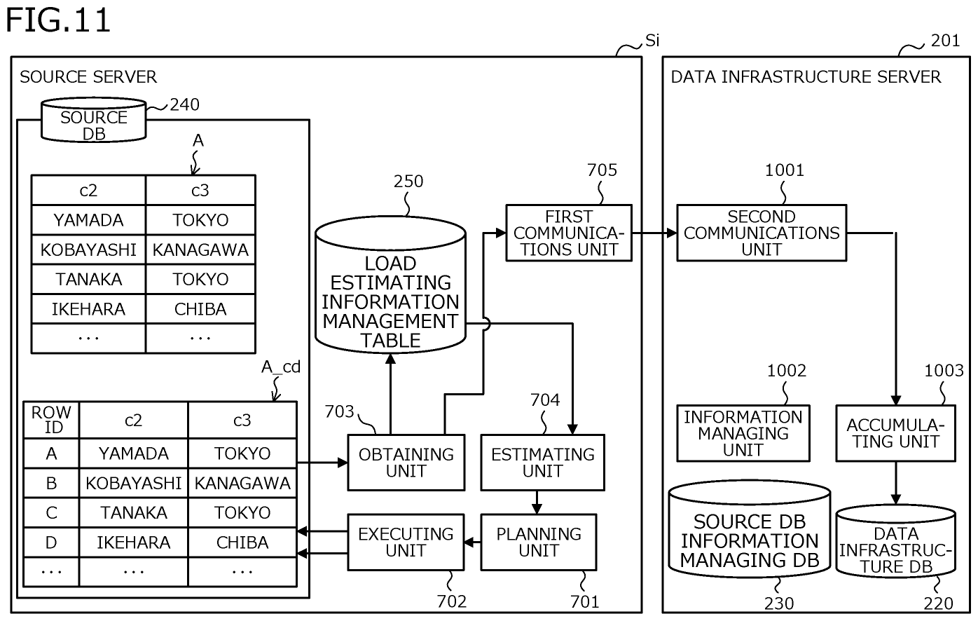

Next, an example of operation of the data linking system 200 is described with reference to FIGS. 10 and 11. First, an example of operation during data linking preparation work is described with reference to FIG. 10.

FIG. 10 is a diagram depicting an example of operation during data linking preparation work for the data linking system 200. In FIG. 10, the data infrastructure server 201 includes a second communications unit 1001, an information managing unit 1002, and an accumulating unit 1003. The second communications unit 1001 to the accumulating unit 1003 are functions constituting a controller, in particular, for example, a program stored in a storage device such as the memory, a disk, a removable recording medium of the data infrastructure server 201 is executed by the CPU or the communications I/F, whereby the functions are implemented. Process results of each of the functional units, for example, are stored to a storage device such as a disk or memory of the data infrastructure server 201.

First, the planning unit 701 of the source server Si receives DB connection information from the manager terminal 202 (refer to FIG. 2), whereby the planning unit 701 sets the received DB connection information into a configuration file (not depicted).

Further, the information managing unit 1002 of the data infrastructure server 201 receives provided configuration data by API or the like from the manager terminal 202 (refer to FIG. 2), whereby the information managing unit 1002 registers the provided configuration data into the source DB information managing DB 230. The information managing unit 1002 of the data infrastructure server 201 outputs the provided configuration data to the second communications unit 1001.

The second communications unit 1001 of the data infrastructure server 201 transmits, to the first communications unit 704 of the source server Si, the provided configuration data received from the information managing unit 1002. The first communications unit 704 of the source server Si outputs the received provided configuration data to the planning unit 701. The planning unit 701 of the source server Si uses the DB connection information identifier of the received provided configuration data as a key, refers to the DB connection information, and identifies the DB engine type.

Subsequently, the planning unit 701 of the source server Si refers to the name of a table to be extracted in the received provided configuration data, retrieves information of the table to be extracted from the system table of the source DB 240, and based on the identified DB engine type, generates a change difference management table creating query and a trigger creating query.

The executing unit 702 of the source server Si executes the generated change difference management table creating query and thereby, creates a change difference management table that corresponds to the table to be extracted. Further, the executing unit 702 of the source server Si executes a trigger creating query and thereby creates a trigger.

As a result, preparation for performing data linking between the source DB 240 of the source server Si and the data infrastructure DB 220 of the data infrastructure server 201 may be performed.

Next, an example of operation during routine operations (data extraction process) is described with reference to FIG. 11. Here, the table to be extracted is assumed to be table A in the source DB 240.

FIG. 11 is a diagram depicting an example of operation during routine operations of the data linking system 200. In FIG. 11, a record is assumed to be added to table A in the source DB 240 by a business application or the like. In this instance, the source server Si, by a trigger, adds to the change difference management table A_cd, the record added to table A.

The executing unit 702 of the source server Si executes a record extraction query for the change difference management table A_cd. The obtaining unit 703 of the source server Si obtains the record extraction result of extraction by an execution of the record extraction query and calculates an extraction query response time and an extraction query execution interval.

The obtaining unit 703 of the source server Si stores, to the load estimating information management table 250, load estimating information that includes a DB connection information identifier, a name of a table to be extracted, extraction success, the number of records extracted, the size of data extracted, the extraction query response time, and the extraction query execution interval.

In an instance in which the extraction process for extracting records from the change difference management table A_cd is successful, the obtaining unit 703 of the source server Si outputs the record extraction result to the first communications unit 704. Further, the executing unit 702 of the source server Si executes a record deletion query with respect to the change difference management table A_cd and thereby, deletes the record extraction result from the change difference management table A_cd.

The first communications unit 704 of the source server Si transmits the received record extraction result to the second communications unit 1001 of the data infrastructure server 201. The second communications unit 1001 of the data infrastructure server 201 outputs the received record extraction result to the accumulating unit 1003. The accumulating unit 1003 of the data infrastructure server 201 stores the received record extraction result to the data infrastructure DB 220.

The estimating unit 704 of the source server Si refers to the load estimating information in the load estimating information management table 250 and estimates the load state of the source DB 240. Based on the estimated load state, the planning unit 701 of the source server Si determines the extraction item count and the extraction query execution interval for the next session and executes the record extraction query.

The executing unit 702 of the source server Si executes the generated record extraction query when the determined extraction query execution interval elapses. As a result, the source server Si may iteratively perform a record extraction process (the data retrieval process) with respect to the change difference management table A_cd while dynamically controlling the extraction item count and the extraction query execution interval according to the load state of the source DB 240.

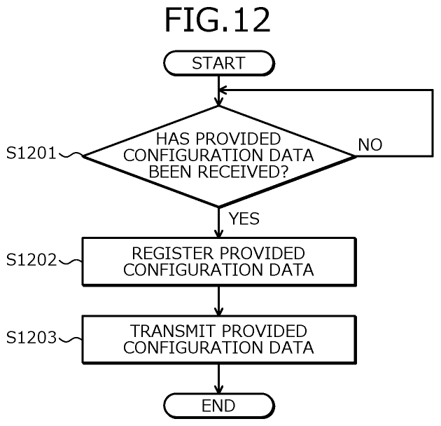

Next, a procedure of a data linking pre-process of the data infrastructure server 201 is described with reference to FIG. 12.

FIG. 12 is a flowchart depicting one example of the procedure of the data linking pre-process of the data infrastructure server 201. In FIG. 12, first, the data infrastructure server 201 determines whether provided configuration data has been received from the manager terminal 202 (step S1201). Here, the data infrastructure server 201 stands by until receiving the provided configuration data (step S1201: NO).

The data infrastructure server 201, when having received provided configuration data (step S1201: YES), registers the received provided configuration data into the source DB information managing DB 230 (step S1202). Subsequently, the data infrastructure server 201 transmits the received provided configuration data to the source server Si (step S1203) and ends the series of processes according to the present flowchart.

As a result, the data infrastructure server 201 may register information in the source database and notify the source server Si that data linking preparation is finished.

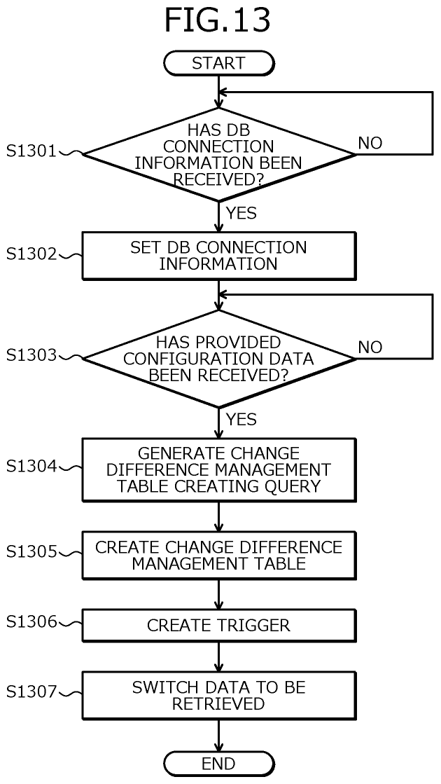

Next, procedures of various processes of the source server Si are described. First, a procedure of the data linking pre-process of the source server Si is described with reference to FIG. 13.

FIG. 13 is a flowchart depicting one example of the procedure of the data linking pre-process of the source server Si. In the flowchart depicted in FIG. 13, first, the source server Si determines whether DB connection information has been received from the manager terminal 202 (step S1301). Here, the source server Si stands by until receiving the DB connection information (step S1301: NO).

The source server Si, when receiving DB connection information (step S1301: YES), sets the received DB connection information in a configuration file (not depicted) (step S1302). Next, the source server Si determines whether provided configuration data has been received from the data infrastructure server 201 (step S1303).

Here, the source server Si stands by until receiving the provided configuration data (step S1303: NO). The source server Si, when having received the provided configuration data (step S1303: YES), generates a change difference management table creating query (step S1304). Subsequently, the source server Si executes the generated change difference management table creating query and thereby creates a change difference management table corresponding to the table to be extracted (step S1305).

Next, the source server Si creates a trigger for inserting, into the change difference management table, information that is the same as that of a record inserted into the table to be extracted (step S1306). Subsequently, the source server Si switches the data to be retrieved, from the table that is to be extracted to the change difference management table (step S1307) and ends the series of processes according to the present flowchart.

As a result, the source server Si may perform preparations for performing data linking between the source DB 240 and the data infrastructure DB 220 of the data infrastructure server 201.

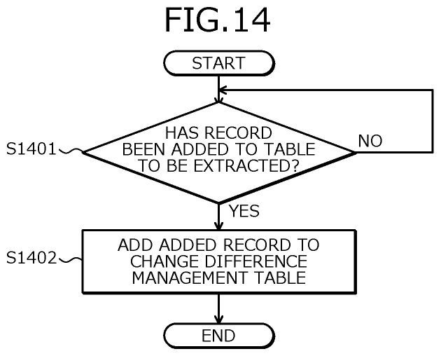

Next, a procedure of a record adding process of the source server Si is described with reference to FIG. 14.

FIG. 14 is a flowchart depicting one example of the procedure of the record adding process of the source server Si. In the flowchart depicted in FIG. 14, first, the source server Si determines whether a record has been added to the table to be extracted in the source DB 240 (step S1401).

To add a record to the table to be extracted, for example, Structured Query Language (SQL) execution commands such as “INSERT INTO table A VALUES (‘Yamada’, ‘Tokyo’);”, “INSERT INTO table A VALUES (‘Kobayashi’, ‘Kanagawa’);”, “INSERT INTO table A VALUES (‘Tanaka’, ‘Tokyo’);”, etc. are used.

Here, the source server Si stands by until a record is added to the table to be extracted (step S1401: NO). When a record has been added to the table to be extracted (step S1401: YES), by a trigger, the source server Si adds, to the change difference management table, the record that has been added to the table to be extracted (step S1402) and ends the series of processes according to the present flowchart.

To add a record to the change difference management table, for example, SQL execution commands such as “INSERT INTO table A_cd (c2,c3) VALUES (‘Yamada’, ‘Tokyo’);”, etc., are used.

Thus, the source server Si may copy data stored in a table to be extracted to the change difference management table.

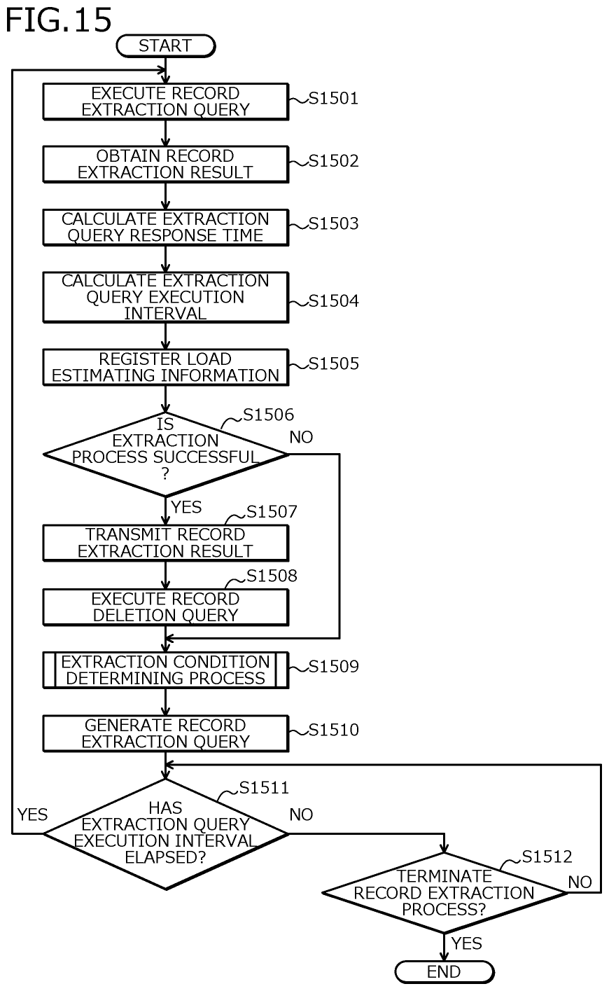

Next, a procedure of the record extraction process of the source server Si is described with reference to FIG. 15.

FIG. 15 is a flowchart depicting one example of the procedure of the record extraction process of the source server Si. In the flowchart depicted in FIG. 15, first, the source server Si executes a record extraction query with respect to the change difference management table (step S1501).

The extraction process (execution of a record extraction query) of the first session, for example, is executed upon completion of the data linking pre-process depicted in FIG. 13. To extract a record from the change difference management table, for example, a SQL execution command such as “SELECT * FROM table A_cd ORDER BY ROWID limit b;” is used.

Subsequently, the source server Si obtains a result (record extraction result) of the record extraction performed by executing the record extraction query (step S1502). Next, the source server Si calculates the extraction query response time (step S1503). Next, the source server Si calculates the extraction query execution interval (step S1504).

Subsequently, the source server Si registers load estimating information into the load estimating information management table 250 (step S1505). The load estimating information, for example, includes the DB connection information identifier, the name of a table to be extracted, whether the extraction is successful, the number of records extracted, the size of data extracted, the extraction query response time, and the extraction query execution interval.

Next, the source server Si determines whether the extraction process is successful (step S1506). Here, when the extraction process fails (step S1506: NO), the source server Si transitions to step S1509.

On the other hand, when the extraction process is successful (step S1506: YES), the source server Si transmits the obtained record extraction result to the data infrastructure server 201 (step S1507). Subsequently, the source server Si executes a record deletion query with respect to the change difference management table and thereby deletes the extracted record from the change difference management table (step S1508). To delete a record from the change difference management table, for example, a SQL execution command such as “DELETE FROM table A_cd WHERE ROWID=1; . . . DELETE FROM table A_cd WHERE ROWID=b;” is used.

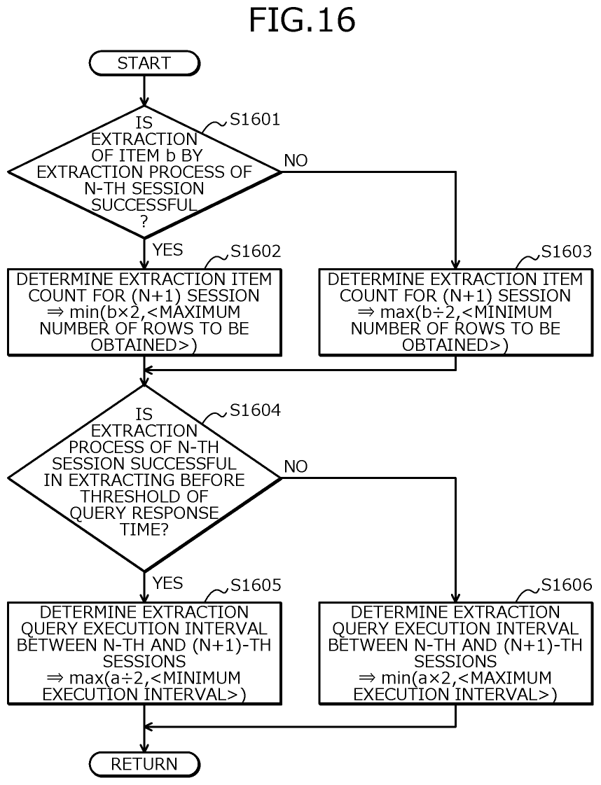

Next, the source server Si executes an extraction condition determining process that determines the number of extractions and the extraction query execution interval for the next session (step S1509). A procedure of the extraction condition determining process is described in detail hereinafter with reference to FIG. 16.

Subsequently, the source server Si generates a record extraction query based on the determined number of extractions (step S1510). The record extraction query, for example, is generated based on the information in the change difference management table and the DB engine type of the source DB 240. Reduction of the extraction item count, for example, may be performed by changing a portion of the character string of the SQL query.

Next, the source server Si determines whether the determined extraction query execution interval has elapsed since the execution of the record extraction query at step S1501 (step S1511). The extraction query execution interval (initial execution interval) until the extraction process of the second session, for example, may be preset.

Here, when the extraction query execution interval has elapsed (step S1511: YES), the source server Si returns to step S1501. On the other hand, when the extraction query execution interval has not elapsed (step S1511: NO), the source server Si determines whether to terminate the record extraction process (step S1512). Termination of the record extraction process, for example, is instructed by the manager terminal 202.

Here, when the record extraction process is not to be terminated (step S1512: NO), the source server Si returns to step S1511. On the other hand, when the record extraction process is to be terminated (step S1512: YES), the source server Si ends the series of processes according to the present flowchart.

Thus, the source server Si may perform data linking between the source DB 240 and the data infrastructure DB 220 of the data infrastructure server 201.

Next, a procedure of the extraction condition determining process at step S1509 is described in detail with reference to FIG. 16.

FIG. 16 is a flowchart depicting a detailed example of the procedure of the extraction condition determining process. In the flowchart depicted in FIG. 16, first, the source server Si determines whether extraction of item b by the extraction process of an N-th session is successful (step S1601). The N-th time corresponds to the extraction process immediately before.

Here, when extraction of item b is successful (step S1601: YES), the source server Si uses formula (1) described above and determines the extraction item count for the (N+1) session (step S1602), and then transitions to step S1604. On the other hand, when extraction of item b fails (step S1601: NO), the source server Si uses formula (2) described above and determines the extraction item count for the (N+1) session (step S1603).

Next, the source server Si determines whether extraction by the extraction process of the N-th session is successful before the threshold a of the query response time (step S1604). However, the source server Si may skip steps S1604 to S1605 immediately after the extraction process of the first session.

Here, when the extraction is successful (step S1604: YES), the source server Si uses formula (3) described above and determines the extraction query execution interval between the N-th and (N+1)-th sessions (step S1605) and returns to the step that called the extraction condition determining process.

On the other hand, when the extraction fails (step S1604: NO), the source server Si uses formula (4) and determines the extraction query execution interval between the N-th and (N+1)-th sessions (step S1606) and returns to the step that called the extraction condition determining process.

Thus, the source server Si may determine the extraction item count and the extraction query execution interval for the next session according to the load state of the source DB 240.

As described above, according to the source server Si of the embodiment, when specification of a first data table constituting data to be retrieved is received, a data table copy that is a copy of the first data table may be generated and the data to be retrieved may be switched from the first data table to the data table copy. The first data table, for example, is a table to be extracted (table A) in the source DB 240. Further, the data table copy, for example, is the change difference management table A_cd. Subsequently, according to the source server Si, to perform the data retrieval process with respect to the data table copy, at least any one of the number of data to be retrieved from the data table copy and the data retrieval interval may be controlled based on the load state estimated from the results of the data retrieval process.

As a result, the source server Si may control the number of data and/or the data retrieval interval when data is iteratively retrieved from a database and reduce the load on the database. For example, according to the load state of the source DB 240, the source server Si may dynamically adjust the execution interval for the record extraction query and/or the number of records to be extracted at one time and thereby, increase the throughput of the extraction process (the data retrieval process) for data linking and suppress adverse effects on the throughput of other DB applications and/or the response time.

Further, according to the source server Si, data retrieved by execution of the data retrieval process may be output to a linked database of the first data table. The linked database, for example, is the data infrastructure DB 220.

Thus, the source server Si may perform data linking between the source DB 240 and the data infrastructure DB 220 of the data infrastructure server 201.

Further, according to the source server Si, the load state may be estimated based on success or failure of the data retrieval process.

Thus, for example, the source server Si may estimate the load to be high when the extraction process (the data retrieval process) fails due to a timeout, intense access of the source DB 240 by other DB applications, etc.

Further, according to the source server Si, the load state may be estimated based on the response time of the data retrieval process.

Thus, the source server Si, for example, may estimate the load to be high when the response time of the extraction process(the data retrieval process) exceeds the threshold a due to intense access of the source DB 240 by other DB applications.

Further, according to the source server Si, a query (for example, record extraction query) for retrieving data of the controlled number of data from the data table copy may be generated based on the DB engine type of the first data table. Subsequently, according to the source server Si, the data retrieval process may be performed with respect to the data table copy by an execution of the generated query.

Thus, the source server Si may switch the SQL query according to the DB engine type and, for example, may minimize the load on a data buffer of the source DB 240 or a disk I/O due to the extraction process and suppress adverse effects on the response time and/or throughput of other DB applications.

Further, according to the source server Si, when the load is estimated to be high from the results of the data retrieval process, control may be performed so that the number of data to be retrieved in the data retrieval process is lower than that when the load is low. Further, according to the source server Si, when the load is estimated to be low from the results of the data retrieval process, control may be performed so that the number of data to be retrieved in the data retrieval process is higher than that when the load is high.

Thus, the source server Si, for example, may suppress the number of records to be extracted at one time when the load on the source DB 240 is a high state and thereby, suppress adverse effects on the throughput and response time of other DB applications. Further, the source server Si may increase the number of records to be extracted at one time when the load on the source DB 240 is low and thereby, enhance the efficiency of the extraction process for the data linking.

Further, according to the source server Si, when the load is estimated to be high from the results of the data retrieval process, control may be performed so that the data retrieval interval is longer than that when the load is low. Further, according to the source server Si, when the load is estimated to be low from the results of the data retrieval process, control may be performed so that the data retrieval interval is shorter than that when the load is high.

Thus, for example, when the load on the source DB 240 is a high state, the source server Si may lengthen the execution interval of the record extraction query and thereby suppress adverse effects on the throughput and response time of other DB applications. Further, when the load on the source DB 240 is a low state, the source server Si may shorten the execution interval of the record extraction query and thereby enhance the efficiency of the extraction process for data linking.

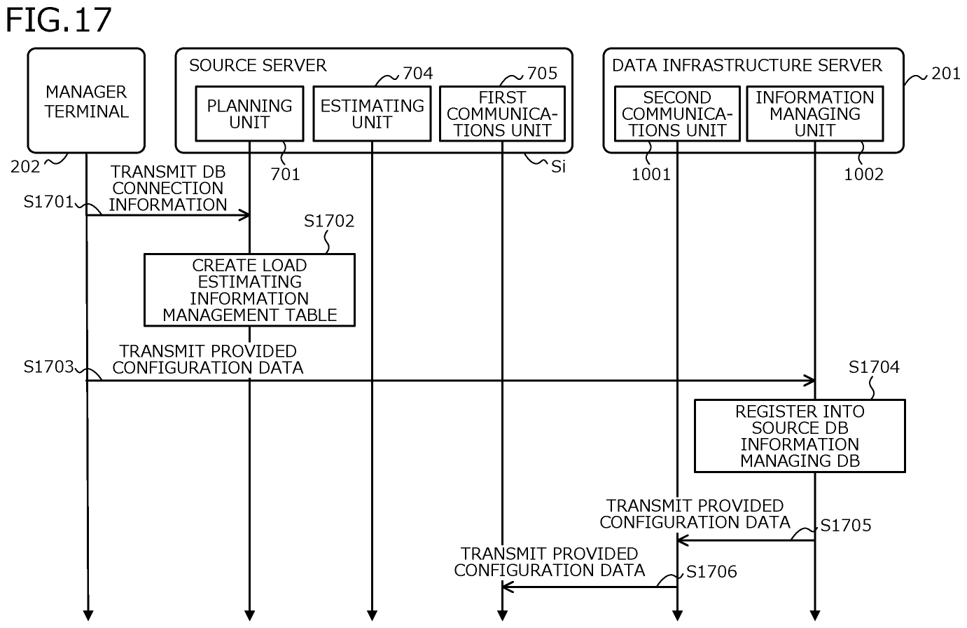

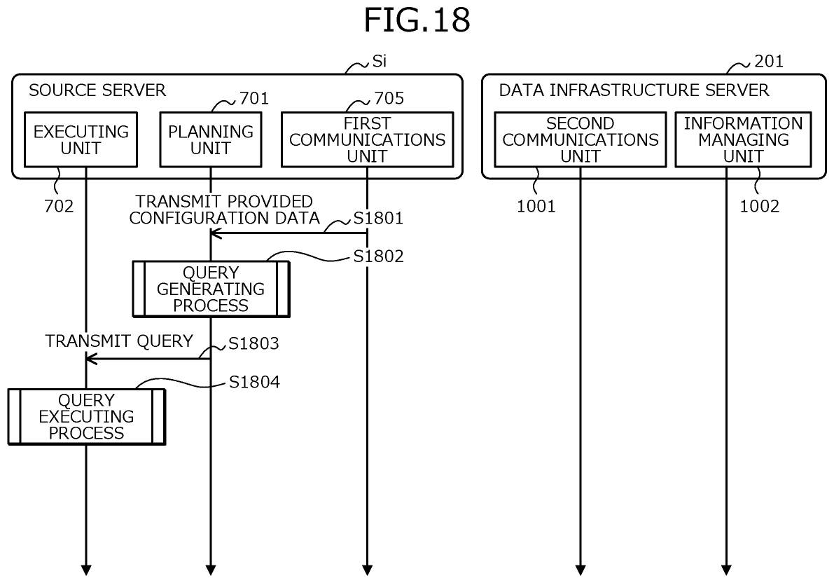

Next, an example of the data linking system 200 is described. First, one example of the data linking pre-process of the data linking system 200 is described with reference to FIGS. 17 and 18.

FIGS. 17 and 18 are sequence diagrams depicting one example of the data linking pre-process of the data linking system 200. In the sequence diagram depicted in FIG. 17, first, the manager terminal 202 transmits the DB connection information to the planning unit 701 of the source server Si (step S1701). As a result, the DB connection information is set in the configuration file of the planning unit 701. The DB connection information includes the DB connection information identifier (main key), the DB engine type, the name of the DB user, the DB password, the database name, the IP address, and the port number (for example, refer to FIG. 8).

Next, the planning unit 701 of the source server Si uses the DB connection information identifier included in the DB connection information and creates the load estimating information management table 250 (step S1702). However, at this time, information is not inserted into the load estimating information management table 250.

The manager terminal 202 transmits the provided configuration data to the information managing unit 1002 of the data infrastructure server 201 (step S1703). The provided configuration data includes the enterprise identifier, the information identifier (main key), the DB connection information identifier, and the name of a table to be extracted (for example, refer to FIG. 9).

The information managing unit 1002 of the data infrastructure server 201 registers the provided configuration data received from the manager terminal 202 into the source DB information managing DB 230 (step S1704). Next, the information managing unit 1002 of the data infrastructure server 201 transmits the registered provided configuration data to the second communications unit 1001 (step S1705).

The second communications unit 1001 of the data infrastructure server 201 transmits the received provided configuration data to the first communications unit 704 of the source server Si (step S1706). At this time, the second communications unit 1001 determines the transmission destination according to the enterprise identifier included in the provided configuration data. The provided configuration data transmitted to the first communications unit 704 of the source server Si may omit the enterprise identifier.

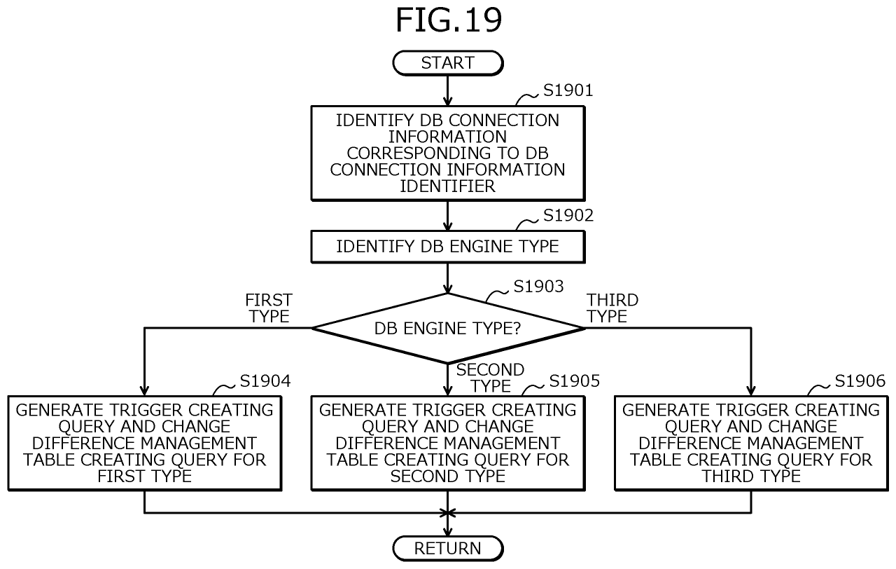

In the sequence diagram depicted in FIG. 18, the first communications unit 704 of the source server Si transmits the received provided configuration data to the planning unit 701 (step S1801). The planning unit 701 of the source server Si, when receiving the provided configuration data, executes a query generating process (step S1802). A procedure of the query generating process is described in detail with reference to FIG. 19.

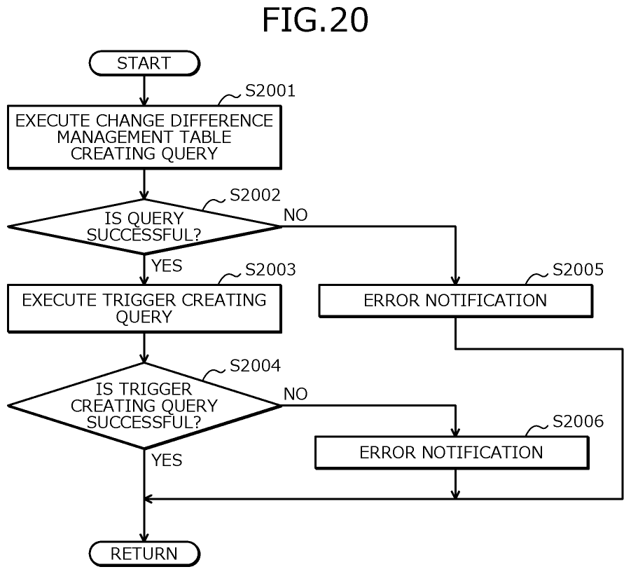

Next, the planning unit 701 of the source server Si transmits the generated queries (change difference management table creating query, trigger creating query) to the executing unit 702 (step S1803). The executing unit 702 of the source server Si, when receiving the queries, executes a query executing process (step S1804). A procedure of the query executing process is described in detail with reference to FIG. 20.

Here, a procedure at step S1802 of the query generating process is described in detail with reference to FIG. 19.

FIG. 19 is a flowchart depicting one example of a procedure of the query generating process. In the flowchart depicted in FIG. 19, first, the planning unit 701 of the source server Si refers to the configuration file and identifies the DB connection information that corresponds to the DB connection information identifier included in the provided configuration data (step S1901).

Next, the planning unit 701 of the source server Si refers to the identified DB connection information and identifies a DB engine type (step S1902). Subsequently, the planning unit 701 of the source server Si determines whether the identified DB engine type is any one of the first type, the second type, and the third type (step S1903). The first type, the second type, and the third type, for example, are OracleL, MySQL, and PostgreSQL, respectively.

Here, in a case of the first type (step S1903: first type), the planning unit 701 of the source server Si generates a trigger creating query and a change difference management table creating query for the first type (step S1904) and returns to the step that called the query generating process. Each query, for example, is generated based on table information (configuration of a table to be extracted) retrieved from a system table of the source DB 240.

Further, in a case of the second type (step S1903: second type), the planning unit 701 of the source server Si generates a trigger creating query and a change difference management table creating query for the second type (step S1905) and returns to the step that called the query generating process.

Further, in a case of the third type (step S1903: third type), the planning unit 701 of the source server Si generates a trigger creating query and a change difference management table creating query for the third type (step S1906) and returns to the step that called the query generating process.

Thus, the planning unit 701 of the source server Si may generate optimal queries according to the DB engine type of the source DB 240.

Next, a procedure of the query executing process at step S1804 is described in detail with reference to FIG. 20.

FIG. 20 is a flowchart depicting one detailed example of a procedure of the query executing process. In the flowchart depicted in FIG. 20, first, the executing unit 702 of the source server Si executes the change difference management table creating query and thereby creates a change difference management table corresponding to the table to be extracted (step S2001).

Next, the executing unit 702 of the source server Si determines whether execution of the change difference management table creating query is successful (step S2002). Here, when the change difference management table creating query is executed successfully (step S2002: YES), the executing unit 702 of the source server Si executes the trigger creating query and thereby creates a trigger (step S2003).

Subsequently, the executing unit 702 of the source server Si determines whether execution of the trigger creating query is successful (step S2004). Here, when the trigger creating query is executed successfully (step S2004: YES), the executing unit 702 of the source server Si returns to the step that called the query executing process.

Further, at step S2002, when execution of the change difference management table creating query fails (step S2002: NO), the executing unit 702 of the source server Si performs error notification (step S2005) and returns to the step that called the query executing process. The error notification, for example, notifies the manager of the source DB 240 of the failure of the execution of the query.

Further, at step S2004, when the execution of the trigger creating query fails (step S2004: NO), the executing unit 702 of the source server Si performs error notification (step S2006) and returns to the step that called the query executing process.

Thus, the executing unit 702 of the source server Si may generate the change difference management table for copying data stored in a table to be extracted in the source DB 240. Further, the executing unit 702 of the source server Si may generate a trigger for inserting, into the change difference management table, information that is the same as that inserted into the table to be extracted.

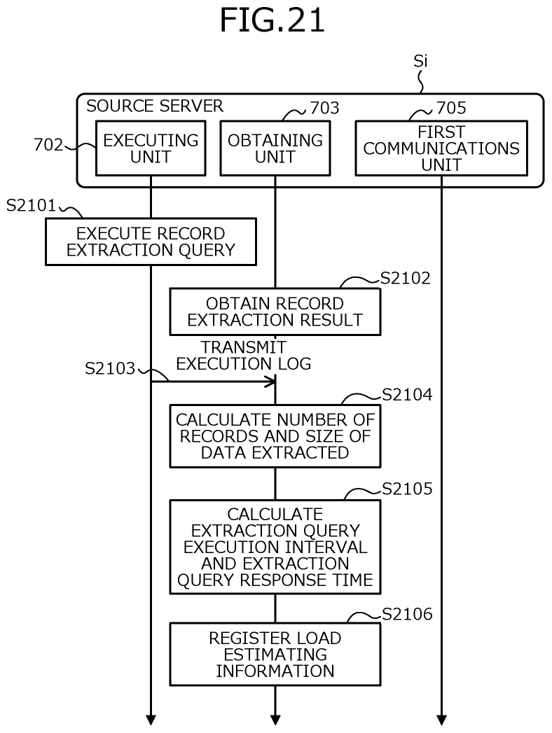

Next, one example of the record extraction process of the data linking system 200 is described with reference to FIGS. 21 to 23.

FIGS. 21, 22, and 23 are sequence diagrams of an example of the record extraction process of the data linking system 200. In the sequence diagram in FIG. 21, first, the executing unit 702 of the source server Si executes a record extraction query with respect to the change difference management table (step S2101).

Next, the obtaining unit 703 of the source server Si executes the record extraction query and thereby obtains the extracted record extraction result (step S2102). The executing unit 702 of the source server Si transmits an execution log of the record extraction query to the obtaining unit 703 (step S2103).

Next, the obtaining unit 703 of the source server Si calculates, from the record extraction result, the number of records and the size of data extracted (step S2104). Further, the obtaining unit 703 of the source server Si calculates, from the execution log of the record extraction query, the extraction query execution interval and the extraction query response time (step S2105).

Subsequently, the obtaining unit 703 of the source server Si registers load estimating information into the load estimating information management table 250 (step S2106). The load estimating information management table 250 corresponds to the DB connection information identifier included in the provided configuration data.

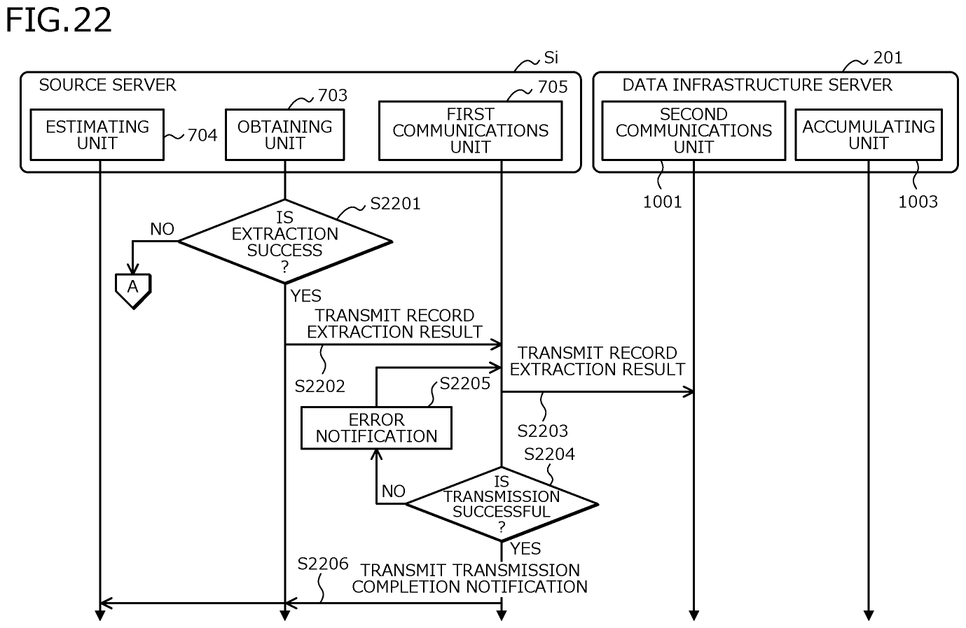

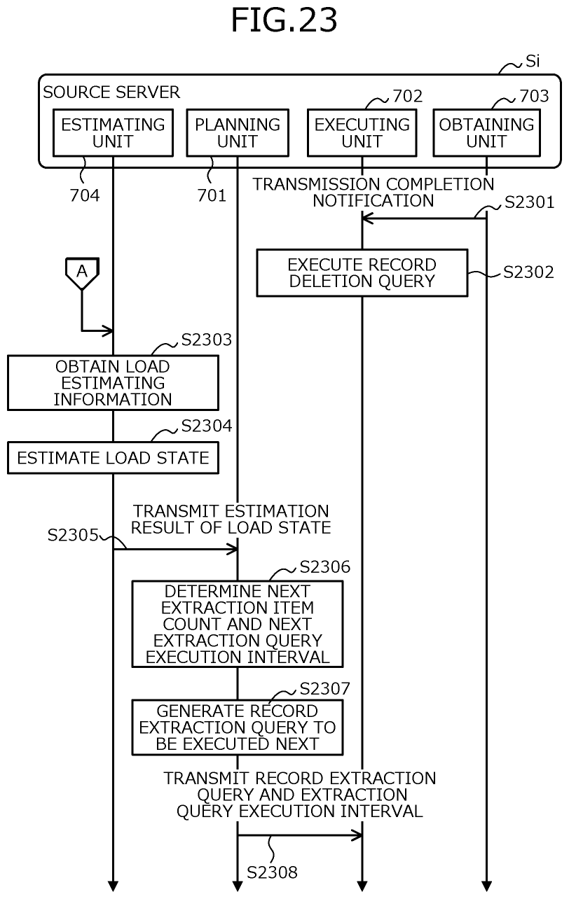

In the sequence diagram depicted in FIG. 22, first, the obtaining unit 703 of the source server Si determines whether the extraction process is successful (step S2201). Here, when the extraction process fails (step S2201: NO), the source server Si transitions to step S2303 depicted in FIG. 23. On the other hand, when the extraction process is successful (step S2201: YES), the obtaining unit 703 of the source server Si transmits the record extraction result to the first communications unit 704 (step S2202). The first communications unit 704 of the source server Si, when receiving the record extraction result, transmits the received record extraction result to the second communications unit 1001 of the data infrastructure server 201 (step S2203). The record extraction result, for example, includes the record retrieved by the extraction process, the name of a table to be extracted, the DB connection information identifier, and the enterprise identifier identified from the provided configuration data.

Subsequently, the first communications unit 704 of the source server Si determines whether transmission of the record extraction result is successful (step S2204). Here, when the transmission fails (step S2204: NO), the first communications unit 704 of the source server Si performs error notification (step S2205) and returns to step S2203 (transmission retry).

On the other hand, when the transmission is successful (step S2204: YES), the first communications unit 704 of the source server Si transmits a transmission completion notification to the obtaining unit 703 and the estimating unit 704 (step S2206).

In the sequence diagram depicted in FIG. 23, first, the obtaining unit 703 of the source server Si, when receiving the transmission completion notification, transmits the transmission completion notification to the executing unit 702 (step S2301). The transmission completion notification, for example, includes the name of a table to be deleted and the number of records to be deleted.

The executing unit 702 of the source server Si, when receiving the transmission completion notification, refers to the name of the table to be deleted and the number of records to be deleted and executes the record deletion query with respect to the change difference management table and thereby, deletes a record (extracted record) from the change difference management table (step S2302).

When the extraction process fails (step S2201: NO) or when receiving the transmission completion notification, the estimating unit 704 of the source server Si obtains from the load estimating information management table 250, the load estimating information that corresponds to the table name and the DB connection information identifier included in the provided configuration data (step S2303). At this time, the estimating unit 704, for example, may obtain the latest load estimating information or may obtain the load estimating information of the past few sessions.

Next, the estimating unit 704 of the source server Si estimates the load state of the source DB 240 based on the obtained load estimating information (step S2304). The estimating unit 704, when obtaining the load estimating information for the past few sessions, may estimate the load state of the source DB 240 from an average of the values indicated by the load estimating information of the past few session.

Further, the estimating unit 704 of the source server Si transmits the estimation result of the load state to the planning unit 701 (step S2305). The planning unit 701 of the source server Si determines the next extraction item count and the next extraction query execution interval based on the estimation result of the received load state (step S2306).

Next, based on the extraction item count determined for the next session, the planning unit 701 of the source server Si generates a record extraction query to be executed next for the next session (step S2307). The record extraction query, for example, is generated based on the information in the change difference management table and the DB engine type of the source DB 240.

Subsequently, the planning unit 701 of the source server Si transmits the generated record extraction query to be executed next and the determined next extraction query execution interval to the executing unit 702 (step S2308). As a result, the source server Si controls the extraction item count and the extraction query execution interval for the next session according to the load state of the source DB 240.

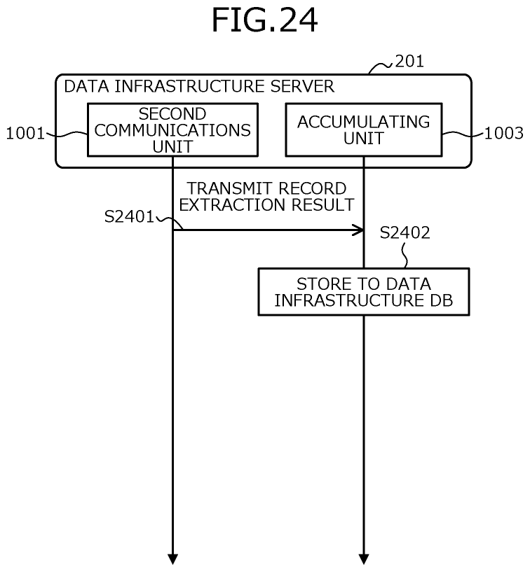

Next, one example of a data linking process of the data linking system 200 is described with reference to FIG. 24.

FIG. 24 is a sequence diagram of one example of the data linking process of the data linking system 200. In the sequence diagram depicted in FIG. 24, first, the second communications unit 1001 of the data infrastructure server 201, when receiving the record extraction result, transmits the received record extraction result to the accumulating unit 1003 (step S2401).

The accumulating unit 1003 of the data infrastructure server 201, when receiving the record extraction result, stores the received record extraction result to the data infrastructure DB 220 (step S2402). At the data infrastructure DB 220, for example, a database for each enterprise identifier is created, a linked table corresponding to the DB connection information identifier and the name of a table to be extracted is created. The linked table is stored in the extracted record.

As a result, the data infrastructure server 201 may perform data linking between the data infrastructure DB 220 and the source DB 240 of the source server Si.

Thus, according to the source server Si of the embodiment, the busy level (the load state) of a database may be estimated, and the execution interval of a SQL query and the number of records to be extracted at one time may be dynamically adjusted according to the busy level. As a result, the source server Si may maximize the throughput of the extraction process while suppressing adverse effects to the response time and throughput of other DB applications. Further, according to the source server Si, a query may be optimized according to DB engine type (for example, Oracle, MySQL, PostgreSQL, etc.). As a result, the source server Si may minimize the load on a disk I/O and/or a data buffer of a database due to the extraction process and may suppress adverse effects in the throughput and response time of other DB applications.

The control method described in the present embodiment may be implemented by executing a prepared program on a computer such as a personal computer and a workstation. The control program is stored on a non-transitory, computer-readable recording medium such as a hard disk, a flexible disk, a CD-ROM, a DVD, a USB memory, etc., read out from the computer-readable medium, and executed by the computer. The control program may be distributed through a network such as the Internet.

Further, the information processing device 101 (the source server Si) described in the present embodiment may be realized by an application specific integrated circuit (ASIC) such as a standard cell or a structured ASIC, or a programmable logic device (PLD) such as a field-programmable gate array (FPGA).

According to one aspect of the present invention, an effect is achieved in that the load on a database may be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control method executed by a computer, the control method comprising:
generating, when specification of a first data table constituting data to be retrieved is received, a data table copy that is a copy of the first data table, and switching the data to be retrieved, from the first data table to the data table copy; and
performing a data retrieval process with respect to the data table copy, wherein
in performing the data retrieval process, at least any one of a number of the data to be retrieved from the data table copy and a data retrieval interval is controlled based on a load state estimated from a result of the data retrieval process.

2. The control method according to claim 1, further comprising
outputting, to a linked database of the first data table, the data retrieved by performing the data retrieval process.

3. The control method according to claim 1, wherein
the load state is estimated based on success or failure of the data retrieval process.

4. The control method according to claim 1, wherein
the load state is estimated based on a response time of the data retrieval process.

5. The control method according to claim 1, wherein
the data table copy is provided in a database having the first data table, and
the control method further comprising:
generating, based on an engine type of the first data table, a query for retrieving the data of the number of the data from the data table copy; and
executing the generated query, thereby, performing the data retrieval process with respect to the data table copy.

6. The control method according to claim 1, wherein
when a load is estimated to be high from the result of the data retrieval process, the controlling includes controlling the number of the data to be smaller as compared to when the load is low, and
when the load is estimated to be low from the result of the data retrieval process, the controlling includes controlling the number of the data to be greater as compared to when the load is high.

7. The control method according to claim 1, wherein
when a load is estimated to be high from the result of the data retrieval process, the data retrieval interval is controlled to be longer as compared to when the load is low, and
when the load is estimated to be low from the result of the data retrieval process, the data retrieval interval is controlled to be shorter as compared to when the load is high.

8. The control method according to claim 3, wherein
the load is estimated to be low when the data retrieval process is successful, and
the load is estimated to be high when the data retrieval process fails.

9. The control method according to claim 4, wherein
the load is estimated to be low when the response time of the data retrieval process is less than a threshold, and
the load is estimated to be high when the response time of the data retrieval process is at least equal to the threshold.

10. A computer-readable medium storing therein a control program that causes a computer to execute a process, the process comprising:
generating, when specification of a first data table constituting data to be retrieved is received, a data table copy that is a copy of the first data table, and switching the data to be retrieved, from the first data table to the data table copy; and
performing a data retrieval process with respect to the data table copy, by controlling any one of a number of the data to be retrieved from the data table copy and a data retrieval interval, based on a load state estimated from a result of the data retrieval process.

11. An information processing device comprising:
a memory; and
a processor coupled to the memory, the processor configured to:
generate, when specification of a first data table constituting data to be retrieved is received, a data table copy that is a copy of the first data table, and switching the data to be retrieved, from the first data table to the data table copy; and
perform a data retrieval process with respect to the data table copy, by controlling any one of a number of the data to be retrieved from the data table copy and a data retrieval interval, based on a load state estimated from a result of the data retrieval process.
